(19) United States
(12) Patent Application Publication
(10) Pub. No.: US 2026/0204959 A1
(43) Pub. Date: Jul. 16, 2026

(54) MOTOR

(71) Applicant: MINEBEA MITSUMI Inc., Kitasaku-gun, Nagano (JP)

(72) Inventor: Tomohisa SUZUKI, Kitasaku-gun, Nagano (JP)

(21) Appl. No.: 19/137,340

(22) PCT Filed: Aug. 25, 2023
(86) PCT No.: PCT/JP2023/030743

§ 371 Date: Jun. 10, 2025

(30) Foreign Application Priority Data
Dec. 22, 2022 (JP) 2022-205688

(51) Int. Cl. H02K 1/14; H02K 1/2706; H02K 3/34

(52) U.S. Cl. CPC H02K 1/14; H02K 1/2706; H02K 3/345

(57) ABSTRACT

Provided is a motor that can improve vibration resistance. The motor includes a casing, a lid covering an opening part of the casing, an annular member including a bus bar, and a stator including a magnetic body and an insulating member covering the magnetic body. The annular member is connected to the lid or the insulating member. Moreover, the magnetic body and the insulating member are connected.

### TECHNICAL FIELD

The present invention relates to a motor.

### BACKGROUND ART

For example, Patent Literature 1 discloses a motor including a bus bar interposed between a lead wire led out from a coil of a stator and a conducting wire to be connected to an external power supply or the like. A stator is disposed below the bus bar. In the stator, a coil is wound around a stator core made of a magnetic body. An insulating member is disposed between the magnetic body and the coil.

### CITATION LIST

### Patent Literature

Patent Literature 1: JP 2014-87087 A

### SUMMARY OF INVENTION

### Technical Problem

In such a motor, components such as the bus bar, the stator core, and the insulating member are held in a casing of the motor. However, in a conventional motor, each component is not necessarily fixed firmly. Therefore, improvement is desired from the viewpoint of vibration resistance.

Thus, one example of an object of the present invention is to provide a motor capable of improving vibration resistance.

### Solution to Problem

A motor according to one aspect of the present invention includes a casing, a lid covering an opening part of the casing, an annular member including a bus bar, and a stator including a magnetic body and an insulating member covering the magnetic body, wherein the annular member is connected to the lid or the insulating member, and the magnetic body and the insulating member are connected.

### BRIEF DESCRIPTION OF DRAWINGS

FIG. 1 is a perspective view schematically illustrating an external appearance of a motor 10 according to a first embodiment of the present invention.

FIG. 2 is a 2-2 cross-sectional view of FIG. 1 along a virtual plane including an axial line x constituting a rotational axis of the motor 10.

FIG. 3 is a 3-3 cross-sectional view of FIG. 1 along a virtual plane orthogonal to the axial line x.

FIG. 4 is an exploded perspective view schematically illustrating a bus bar unit 50 and a lid 42 according to one specific example.

FIG. 5 is a perspective view schematically illustrating a structure of an insulator 33 according to one specific example.

FIG. 6 is a partial cross-sectional view corresponding to the cross-sectional view of FIG. 3. In the partial cross-sectional view, one insulator 33 and one tooth 35 are taken out.

FIG. 7 is a cross-sectional view corresponding to FIG. 6 and illustrating a situation of attaching the insulator 33 to the tooth 35.

FIG. 8 is a perspective view schematically illustrating a structure of a motor 10A according to a second embodiment of the present invention.

FIG. 9 is an exploded perspective view schematically illustrating the structure of the motor 10A according to the second embodiment of the present invention.

FIG. 10 is an exploded perspective view schematically illustrating a structure of a bus bar unit 50A according to another specific example.

FIG. 11 is a perspective view schematically illustrating a structure of an insulator 33 according to one specific example.

FIG. 12 is a plan view schematically illustrating a structure of an insulator 33 according to one specific example.

FIG. 13 is a partial cross-sectional view illustrating a state of an insulator 33 being received by a tooth 35.

FIG. 14 is a cross-sectional view illustrating the state of the insulator 33 being received by the tooth 35.

FIG. 15 is a plan view of a stator 30A. The plan view schematically illustrates a structure of a motor 10B according to a third embodiment of the present invention.

FIG. 16 is a perspective view schematically illustrating structures of an insulator 33A and a tooth 35A according to another specific example.

FIG. 17 is a plan view schematically illustrating structures of an insulator 33A and a tooth 35A according to another specific example.

FIG. 18 is a partial cross-sectional view illustrating a state of an insulator 33A being received by a tooth 35A.

FIG. 19 is a cross-sectional view illustrating a situation of the insulator 33A being received by the tooth 35A.

### DESCRIPTION OF EMBODIMENTS

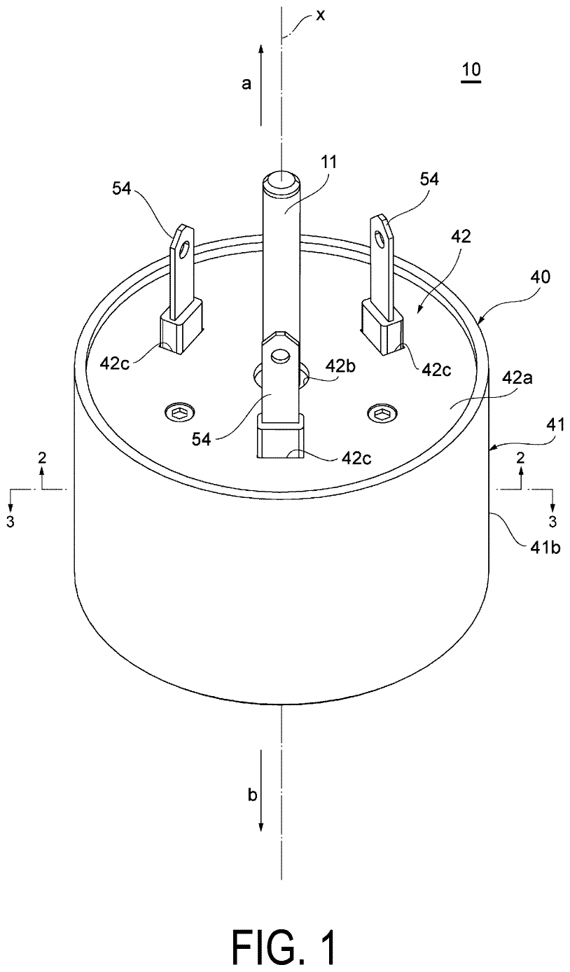

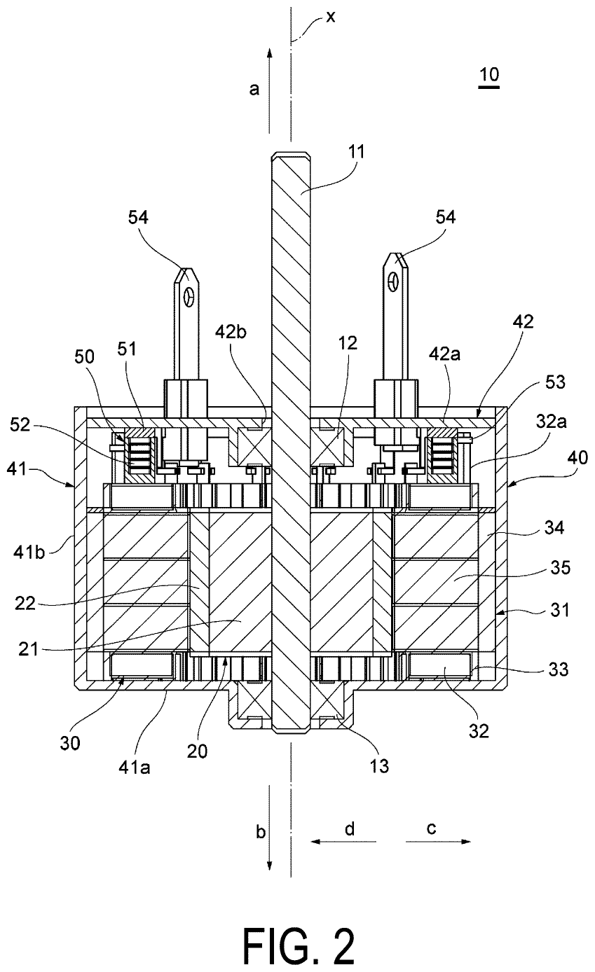

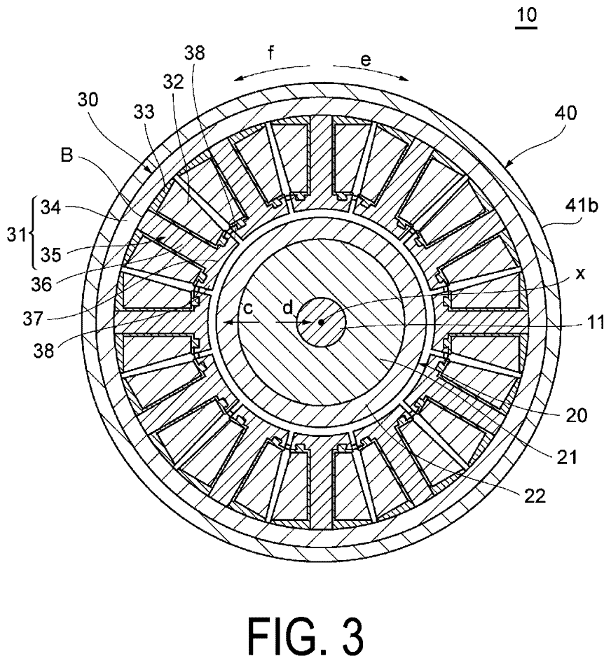

An embodiment of the present invention will be described below with reference to the accompanying drawings. FIG. 1 is a perspective view schematically illustrating an external appearance of a motor 10 according to a first embodiment of the present invention, FIG. 2 is a longitudinal cross-sectional view of the motor 10, and FIG. 3 is a transverse cross-sectional view of the motor 10. Here, FIG. 2 corresponds to a 2-2 cross-sectional view of FIG. 1 along a virtual plane including an axial line x constituting a rotation axis of the motor 10, and FIG. 3 corresponds to a 3-3 cross-sectional view of FIG. 1 along a virtual plane orthogonal to the axial line x.

In the description of the present embodiment, one side in a direction of the axial line x is defined as an upper side a, and the other side in the direction of the axial line x opposite to the one side is defined as a lower side b. Here, the upper side a and the lower side b do not necessarily match the vertical relation in the direction of gravity. Additionally, in a radial direction of the motor 10 perpendicular to the axial line x, a side away from the axial line x is defined as an outer peripheral side c and a side toward the axial line x is defined as an inner peripheral side d. Furthermore, in a circumferential direction around the axial line x, there are defined a clockwise direction e and a counterclockwise direction f seen from the upper side a (see FIG. 3).

As illustrated in FIGS. 1 to 3, the motor 10 according to the first embodiment includes a shaft 11 constituting a rotation shaft, a rotor 20, a stator 30, a casing 40, and an annular member, that is, a bus bar unit 50. The rotor 20 is fixed to the shaft 11. The stator 30 is disposed to surround the rotor 20. The casing 40 holds the stator 30. The bus bar unit 50 supplies a current to the stator 30. The motor 10 is a brushless motor of an inner rotor type.

The shaft 11 and the rotor 20 rotate relative to the casing 40 and the stator 30. Note that the casing 40 and the stator 30 are fixed to, for example, an external device (not illustrated) incorporated with the motor 10.

As illustrated in FIG. 2, the shaft 11 is rotatably supported by two bearings 12 and 13 fixed to the casing 40. The bearings 12 and 13 are attached between the shaft 11 and the casing 40 by, for example, press-fitting. The rotor 20 includes a rotor core 21 and a magnet 22. The rotor core 21 is a cylindrical magnetic body fixed to the shaft 11. The magnet 22 is a cylindrical permanent magnet fixed to an outer peripheral surface of the rotor core 21. The rotor core 21 is formed of a stacked body of a plurality of magnetic bodies stacked in the direction of the axial line x. The shaft 11 is inserted in and fixed to a hole of the rotor core 21 formed along the axial line x.

In contrast, the stator 30 includes a stator core 31, a coil 32, and an insulator 33. The stator core 31 is fixed to the casing 40. The coil 32 is wound around the stator core 31. The insulator 33 is an insulating member disposed between the stator core 31 and the coil 32. The stator core 31 is formed of a stacked body of magnetic bodies, such as silicon steel plates, that is, metallic materials. The insulators 33 are formed of, for example, a resin material.

As illustrated in FIG. 3, the stator core 31 includes a cylindrical annular part 34 and a plurality of teeth 35. The plurality of teeth 35 extend from an inner peripheral surface of the annular part 34 toward the inner peripheral side d in the radial direction. The stator core 31 is fixed to the casing 40 at an outer peripheral surface of the annular part 34. Each tooth 35 is divided from the annular part 34 at a boundary line B defined along an outer peripheral end at the outer peripheral side c. Each tooth 35 is fixed to the inner peripheral surface of the annular part 34 at its outer peripheral end. For example, an adhesive or welding is used for the fixing. In other words, the stator core 31 is divided cores.

Each tooth 35 includes a spoke 36 and a magnetic pole part 37. The spoke 36 extends in the radial direction. The magnetic pole part 37 continues to an inner peripheral end of the spoke 36. The magnetic pole part 37 includes two protruding parts 38. The two protruding parts 38 protrude from the spoke 36 in opposite directions in the circumferential direction. At an inner peripheral surface of the magnetic pole part 37, the tooth 35 faces an outer peripheral surface of the magnet 22 with a predetermined magnetic gap.

The coil 32 is wound around each spoke 36. The insulator 33 disposed between the spoke 36 and the coil 32 insulates the stator core 31 from the coil 32. As illustrated in FIG. 2, for example, one lead wire 32a is led out from each coil 32 and connected to the bus bar unit 50. When a current is supplied to the coil 32 through this lead wire 32a, interaction with a magnetic field generated by the magnet 22 causes the rotor 20 to rotate about the axial line x. As a result, the rotor 20, that is, the shaft 11 rotates relative to the stator 30 and the casing 40 in the clockwise direction e or the counterclockwise direction f.

As illustrated in FIG. 2, the casing 40 includes, for example, a tubular casing main body 41 and, for example, a disc-shaped lid 42. The casing main body 41 is open at the upper side a and closed at the lower side b. The lid 42 covers an opening part of the casing main body 41 at the upper side a. The casing main body 41 includes, for example, a bottom part 41a having a disc shape and an outer peripheral part 41b extending, in a tubular shape, from an outer peripheral edge of the bottom part 41a toward the upper side a. The stator core 31 is fixed to an inner peripheral surface of the outer peripheral part 41b. On the other hand, the cover 42 includes a disc-shaped flat plate part 42a. The flat plate part 42a is provided with a circular opening part 42b at the center of the flat plate part 42a, and, for example, three opening parts 42c formed around the opening part 42b. The shaft 11 protrudes from the opening part 42b toward the upper side a.

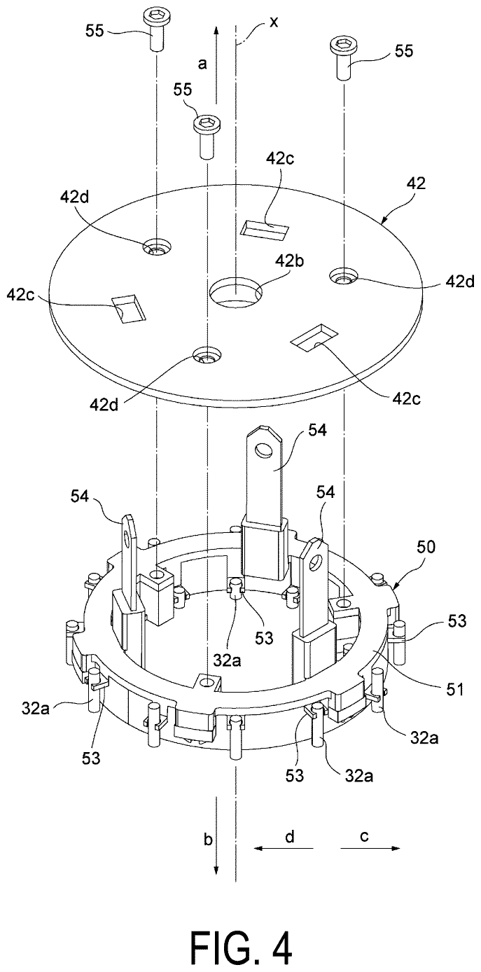

FIG. 4 is an exploded perspective view schematically illustrating the bus bar unit 50 and the lid 42 according to one specific example. Referring to FIGS. 2 and 4 together, the bus bar unit 50 includes an annular housing 51 and a plurality of annular bus bars 52. The plurality of bus bars 52 are accommodated in the housing 51. That is, the bus bar unit 50 is an annular member including the plurality of bus bars 52. The plurality of bus bars 52 are stacked in the direction of the axial line x in the housing 51. The housing 51 is formed of an insulating material including a resin material. The bus bar 52 is formed of a conductive material including a metallic material, such as copper or aluminum.

Each bus bar 52 includes one or more connection terminals (hereinafter referred to as “internal connection terminals”) 53 and one or more connection terminals (hereinafter referred to as “external connection terminals”) 54. The internal connection terminal 53 protrudes outward from the housing 51 toward the outer peripheral side c and the inner peripheral side d in the radial direction. The external connection terminal 54 protrudes outward from the housing 51 in the direction of the axial line x. The internal connection terminal 53 and the external connection terminal 54 are arranged at predetermined intervals around the axial line x. Each internal connection terminal 53 is, for example, a fork-shaped terminal. The lead wire 32a of the coil 32 is electrically connected to the internal connection terminal 53. On the other hand, the external connection terminal 54 protrudes outward of the motor 10 through the opening part 42c formed in the lid 42 of the casing 40. The external connection terminal 54 is electrically connected to an external device (not illustrated).

As illustrated in FIG. 4, the bus bar unit 50 is fixed to the lid 42 with one or more screws 55, for example, three screws 55. The screw 55 is screwed into the housing 51 of the bus bar unit 50 via through hole 42d formed in the flat plate part 42a of the lid 42 at predetermined intervals around the axial line x, for example. For example, a metallic female screw member (not illustrated) is embedded in the housing 51. As is apparent from FIG. 2, an upper surface of the housing 51 is in close contact with a lower surface of the flat plate part 42a. In this way, the bus bar unit 50 is connected to the lid 42. Note that although the bus bar unit 50 is connected to the lid 42 via the screws 55, that is, other members, the bus bar unit 50 may be directly connected to the lid 42 with, for example, an adhesive or the like.

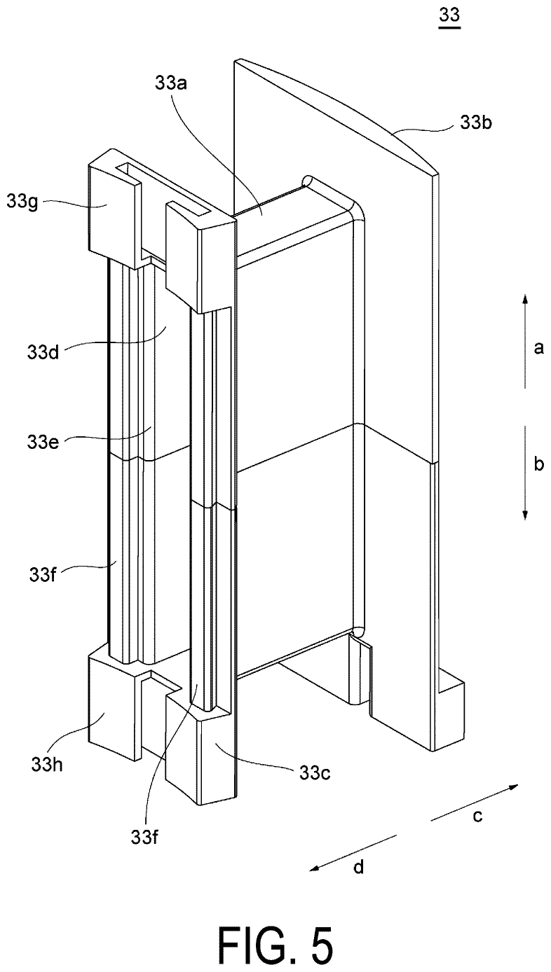

FIG. 5 is a perspective view schematically illustrating a structure of the insulator 33 according to one specific example. As illustrated in FIG. 5, the insulator 33 includes an annular part 33a, a flange 33b at the outer peripheral side c (hereinafter referred to as an “outer peripheral side flange”), and a flange 33c at the inner peripheral side d (hereinafter referred to as an “inner peripheral side flange”). The outer peripheral side flange 33b is integrated with an outer peripheral end of the annular part 33a. The inner peripheral side flange 33c is integrated with an inner peripheral end of the annular part 33a. The annular part 33a defines a space 33d for receiving the spoke 36 in the annular part 33a.

The outer peripheral side flange 33b and the inner peripheral side flange 33c extend, for example, along cylindrical surfaces centered on the axial line x. A pair of fitting parts 33f extending along an opening 33e of the space 33d at the inner peripheral side d is formed at an inner peripheral surface of the inner peripheral side flange 33c. In the present embodiment, the inner peripheral side flange 33c defines, for example, an upper end part 33g at the upper side a and a lower end part 33h at the lower side b in the direction of the axial line x. The upper end part 33g extends from the annular part 33a toward the upper side a. On the other hand, the lower end part 33h extends from the annular part 33a toward the lower side b. The fitting part 33f is, for example, a protruding part extending between the upper end part 33g and the lower end part 33h. In addition, the fitting part 33f is the protruding part protruding from the inner peripheral side flange 33c toward the inner peripheral side d in the radial direction.

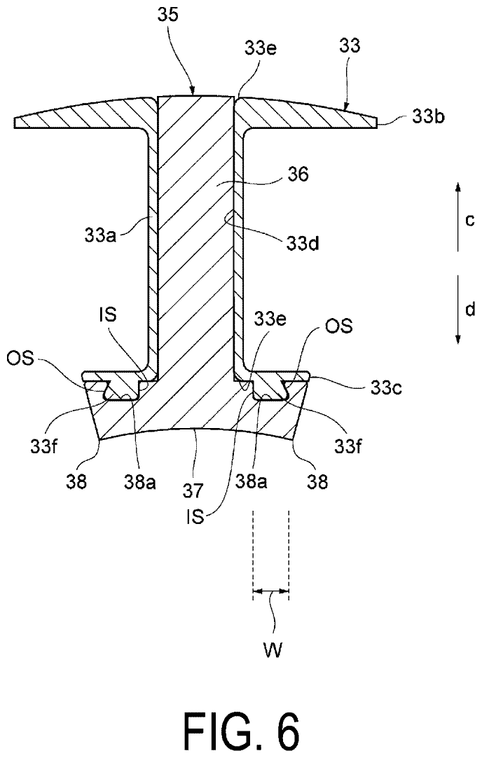

FIG. 6 is a partial cross-sectional view corresponding to the cross-sectional view of FIG. 3. In the partial cross-sectional view, one insulator 33 and one tooth 35 are taken out. Referring also to FIG. 6, in a state of the tooth 35 being disposed in the space 33d of the annular part 33a of the insulator 33, an outer peripheral surface of the protruding part 38 of the tooth 35 faces the inner peripheral side flange 33c of the insulator 33. A fitted part 38a corresponding to the fitting part 33f of the insulator 33 is formed at the outer peripheral surface of the protruding part 38. The fitted part 38a is a recessed part defined along the axial line x and recessed toward the inner peripheral side d in the radial direction. The fitting part 33f of the insulator 33 is fitted to the fitted part 38a of the protruding part 38. By this fitting, the insulator 33 and the tooth 35 are connected to each other in the radial direction.

In a cross section along a virtual plane orthogonal to the axial line x, a contour of the fitting part 33f increases in width W defined in the circumferential direction toward the inner peripheral side d in the radial direction. Specifically, in the present embodiment, in the pair of fitting parts 33f and 33f, inside surfaces IS in the circumferential direction opposing each other extend in the radial direction, while outside surfaces OS in the circumferential direction opposing away from each other become farther away from the inside surfaces IS toward the inner peripheral side d in the radial direction. In a cross-sectional view, the fitted part 38a has the same contour as the fitting part 33f. That is, in the pair of fitted parts 38a and 38a, inside surfaces IS in the circumferential direction opposing each other extend in the radial direction, while outside surfaces OS in the circumferential direction opposing away from each other become farther away from the inside surfaces IS toward the inner peripheral side d in the radial direction.

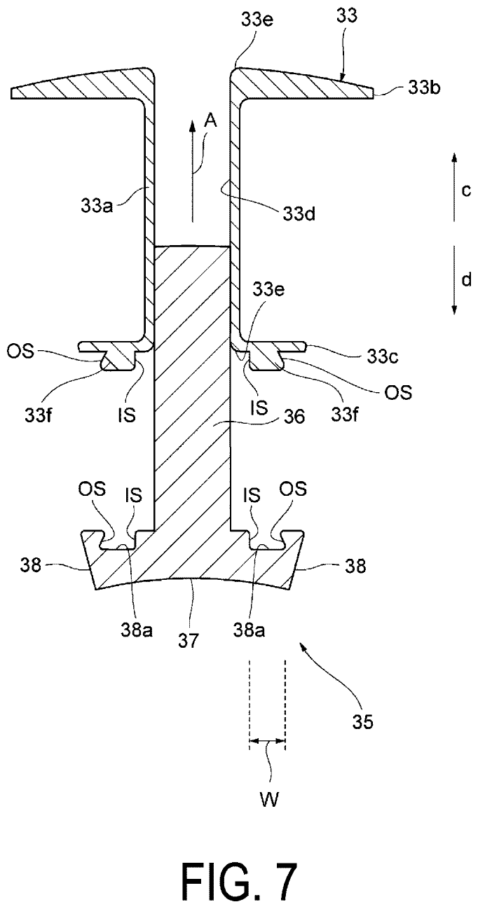

FIG. 7 is a cross-sectional view corresponding to FIG. 6 and illustrating a situation of attaching the insulator 33 to the tooth 35. At the time of attachment, the tooth 35 is inserted into the space 33d of the annular part 33a from the opening 33e at the inner peripheral side flange 33c side of the insulator 33 along an arrow A. A width W of an entry of the fitted part 38a in the circumferential direction is smaller than a width W of the fitting part 33f at the inner peripheral side d in the circumferential direction. Therefore, when the fitting part 33f starts to enter the fitted part 38a, the fitting part 33f made of resin material is elastically deformed. When the fitting part 33f completely enters the fitted part 38a, the fitting part 33f returns to the original shape by an elastic restoring force. In this way, the tooth 35, that is, the stator core 31 is connected to the insulator 33 in the radial direction.

In the motor 10 according to the first embodiment of the present invention as described above, the annular bus bar unit 50 including the bus bar 52 is connected to the lid 42 of the casing 40 via, for example, the screw 55. Since the lid 42 of the casing 40 is a relatively strong structure, vibration resistance of the bus bar unit 50 is remarkably improved. Since the bus bar unit 50 is a component having a relatively heavy weight among the components of the motor 10, the connecting to the lid 42 is particularly useful for improving vibration resistance. Further, the fitting part 33f of the insulator 33 is fitted to the fitted part 38a of the teeth 35 in the radial direction, for example. As a result, vibration resistance of an assembly including the stator core 31, the coil 32, and the insulator 33 is remarkably improved.

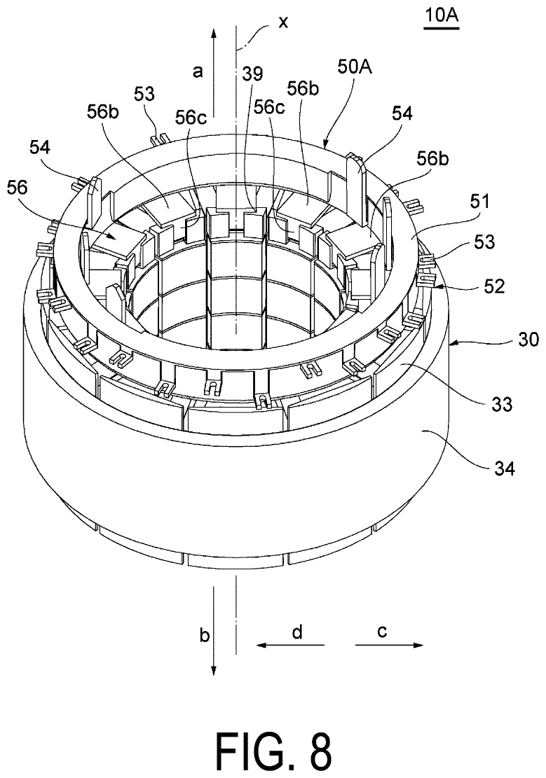

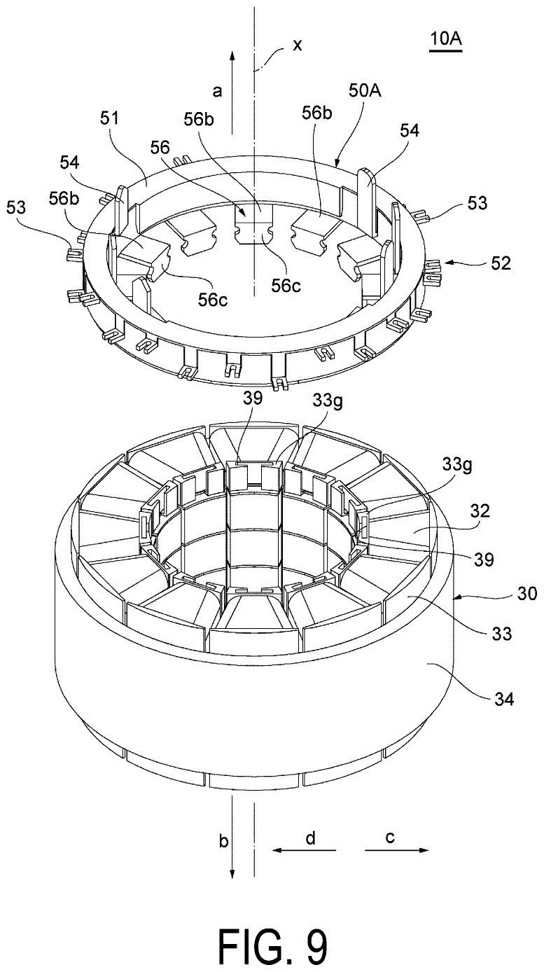

FIG. 8 is a perspective view schematically illustrating a structure of a motor 10A according to a second embodiment of the present invention, and FIG. 9 is an exploded perspective view schematically illustrating the structure of the motor 10A according to the second embodiment of the present invention. In FIGS. 8 and 9, a shaft 11, bearings 12 and 13, a rotor 20, and a casing 40 having substantially the same configurations as the shaft, the bearings, the rotor, and the casing of the motor 10 according to the first embodiment are omitted. In the motor 10A according to the second embodiment, a bus bar unit 50A is incorporated instead of the bus bar unit 50 of the motor 10 according to the first embodiment. In the following drawings, the same components as the components of the motor 10 according to the first embodiment are denoted by the same reference numerals, and redundant description will be omitted.

Referring to FIGS. 8 and 9 together, the bus bar unit 50A is connected to a stator 30 instead of being connected to a lid 42 of the casing 40 via a screw 55 as in the first embodiment. That is, configurations other than the configuration of connecting the bus bar unit 50A to the stator 30 are the same as the configurations of the motor 10 according to the first embodiment. In the bus bar unit 50A, an internal connection terminal 53 of a bus bar 52 protrudes only toward the outer peripheral side c in the radial direction. Although the number and shape of external connection terminals 54 are different from the number and shape of the external connection terminals 54 of the first embodiment, the external connection terminal 54 has the same function as the external connection terminal 54 of the first embodiment.

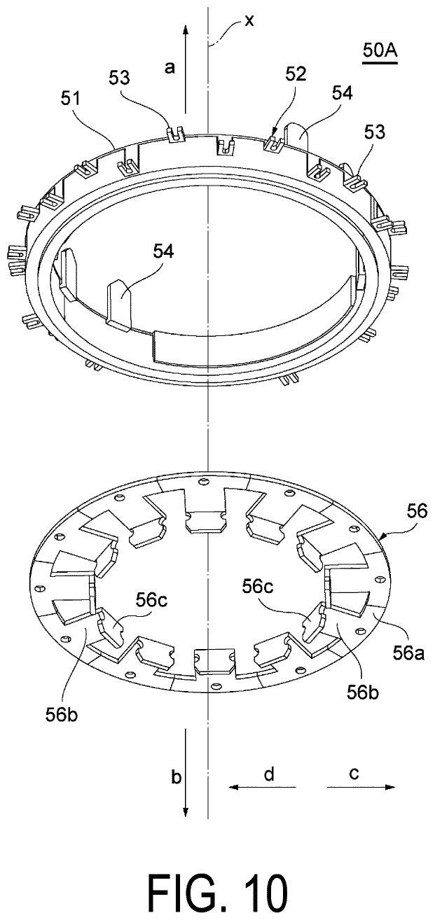

The bus bar unit 50A includes a fixing member 56 for fixing the bus bar unit 50A to the stator 30, that is, an insulator 33. As illustrated in FIG. 10, the fixing member 56 includes an annular main body 56a centered on the axial line x and a plurality of leg parts 56b. Each leg part 56b protrudes from the main body 56a toward the inner peripheral side d in the radial direction. The fixing member 56 is attached to a lower surface of the housing 51 at the main body 56a. The number of the leg parts 56b corresponds to the number of the insulators 33 of the stator 30, and thus the leg parts 56b are arranged at the same intervals as the insulators 33 in the circumferential direction. The leg part 56b includes a piece (hereinafter referred to as “a connecting piece”) 56c extending toward the lower side b. As illustrated in FIG. 8, the connecting piece 56c extends toward the insulator 33 in the direction of the axial line x and is connected to an upper end part 33g of the insulator 33. Details of the connecting will be described below.

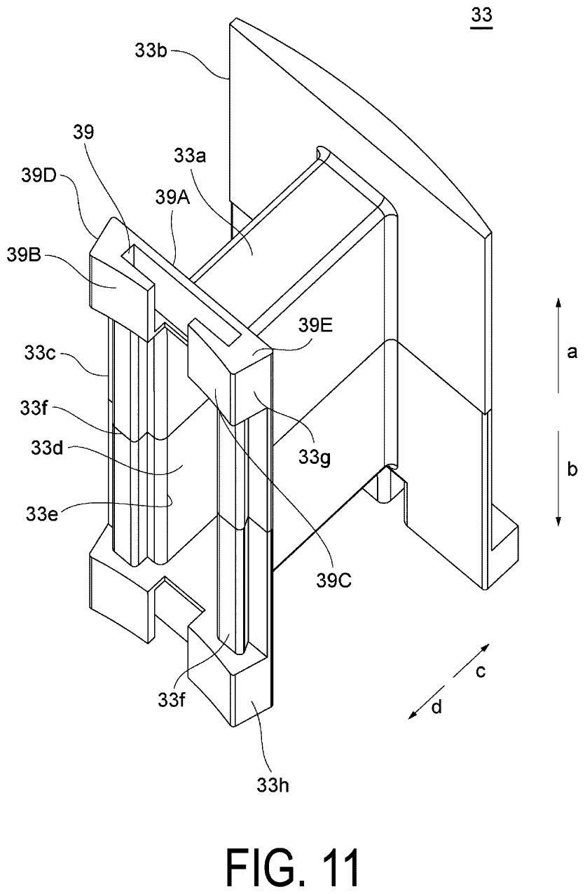

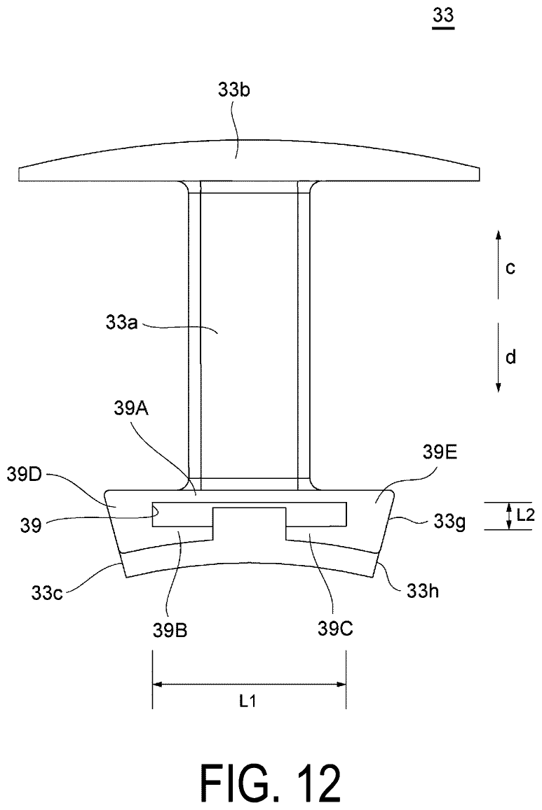

FIG. 11 is a perspective view schematically illustrating a structure of the insulator 33 according to one specific example, and FIG. 12 is a plan view schematically illustrating a structure of the insulator 33 according to one specific example. The insulator 33 has a configuration similar to the configuration of the insulator 33 described above. Here, the structure of the upper end part 33g will be described in detail with reference to FIGS. 11 and 12 together. Redundant description of a configuration other than the configuration of the upper end part 33g will be omitted. In a state of the insulator 33 being incorporated in the motor 10A, the upper end part 33g extends toward the bus bar unit 50A in the direction of the axial line x. The upper end part 33g includes a recessed part 39 for receiving each leg part 56b of the fixing member 56 of the bus bar unit 50A.

The recessed part 39 is surrounded by a peripheral wall 39A of the upper end part 33g at the outer peripheral side c, a pair of peripheral walls 39B and 39C opposing the peripheral wall 39A at the inner peripheral side d, and a pair of side walls 39D and 39E connecting the peripheral wall 39A and the peripheral walls 39B and 39C with each other. The pair of side walls 39D and 39E oppose each other. Since a predetermined gap is left between the pair of peripheral walls 39B and 39C, the recessed part 39 is in a state of being cut out between the peripheral walls 39B and 39C. At the upper end part 33g, a first length L1 is defined between the side walls 39D and 39E, and a second length L2 is defined between the peripheral wall 39A and the peripheral walls 39B and 39C. As will be described below, the first length L1 and the second length L2 are defined in accordance with the size of the leg part 56b of the fixing member 56.

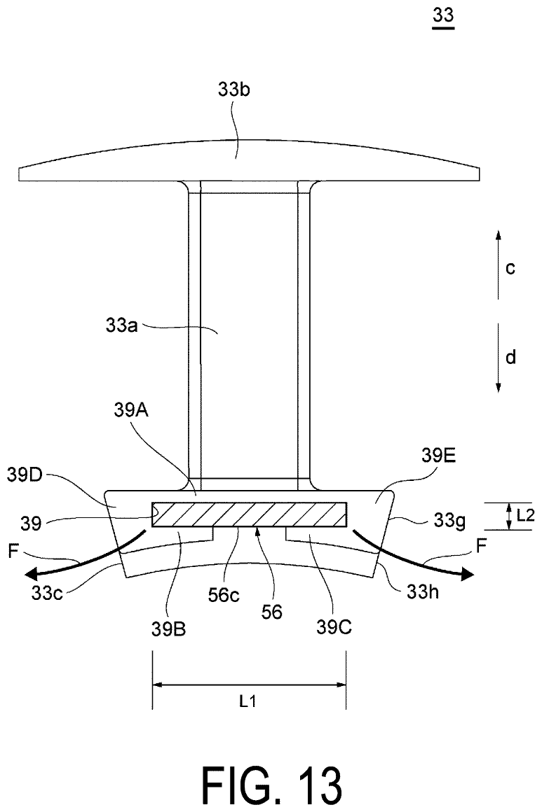

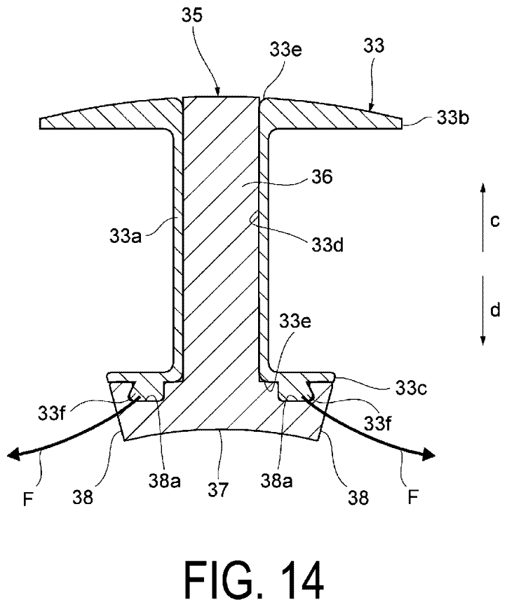

As illustrated in FIG. 13, when the bus bar unit 50A is connected to the stator 30, the connecting piece 56c of the fixing member 56 is press-fitted into the recessed part 39 of the upper end part 33g of the insulator 33. That is, one or both of a first length L1 and a second length L2 of the connecting piece 56c defined in a manner corresponding to the recessed part 39 are set to be larger than the first length LI and the second length L2 of the recessed part 39. As a result, when the connecting piece 56c is press-fitted into the recessed part 39, the connecting piece 56c exerts a stress of pushing out the recessed part 39, for example, in directions of arrows F. As illustrated in FIG. 14, this stress acts in directions of further pushing the fitting parts 33f of the insulator 33 into the fitted parts 38a. As a result, the press-fitting of the connecting piece 56c into the recessed part 39 further strengthens the connecting of the stator core 30 of the insulator 33. Note that the connecting piece 56c and the recessed part 39 may be bonded with an adhesive or the like.

In the motor 10A according to the second embodiment of the present invention as described above, the annular bus bar unit 50A including the bus bar 52 is connected to the stator 30 by the connecting between the connecting piece 56c of the fixing member 56 and the recessed part 39 of the insulator 33. Vibration resistance of the bus bar unit 50A is remarkably improved. Moreover, the connecting between the connecting piece 56c and the recessed part 39 further strengthens the fitting between the fitting part 33f of the stator core 31 and the fitted part 38a of the insulator 33. As a result, vibration resistance of an assembly including the stator core 31, the coil 32, the insulator 33, and the bus bar unit 50A is remarkably improved.

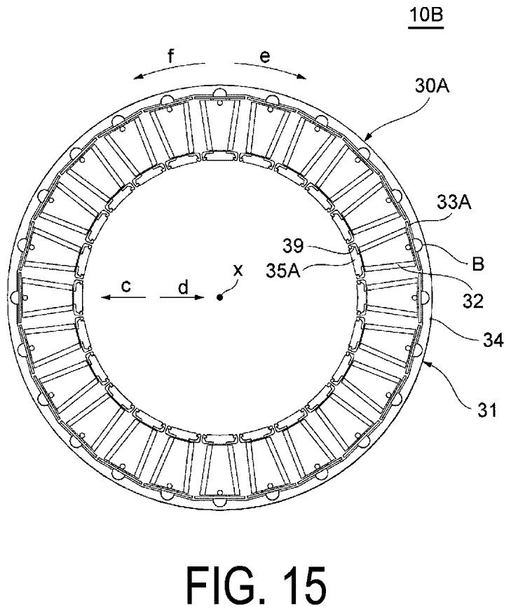

FIG. 15 is a plan view of a stator 30A. The plan view schematically illustrates a structure of a motor 10B according to a third embodiment of the present invention. In FIG. 15, a shaft 11, bearings 12 and 13, a rotor 20, a casing 40, and a bus bar unit 50A having substantially the same configurations as the shafts, the bearings, the rotors, the casings, and the bus bar units of the motors 10 and 10A according to the first and second embodiments are omitted. In the motor 10B according to the third embodiment, the stator 30A different from the stators 30 of the motors 10 and 10A according to the first and second embodiments is incorporated. In the following drawings, the same components as the components of the motors 10 and 10A according to the first and second embodiments are denoted by the same reference numerals, and redundant description will be omitted.

As illustrated in FIG. 15, the stator 30A includes an insulator 33A instead of the insulator 33 described above, and includes a tooth 35A instead of the tooth 35 described above. The stator 30A has basically the same configuration as the stator 30 except for the configurations of the insulator 33A and the tooth 35A, but as is clear from FIG. 15, in the third embodiment, the number of coils 32 is increased from twelve to twenty-four as compared with the first and second embodiments. Therefore, the number of connecting pieces 56c of a fixing member 56 of the bus bar unit 50A (not illustrated) is correspondingly increased from twelve to twenty-four.

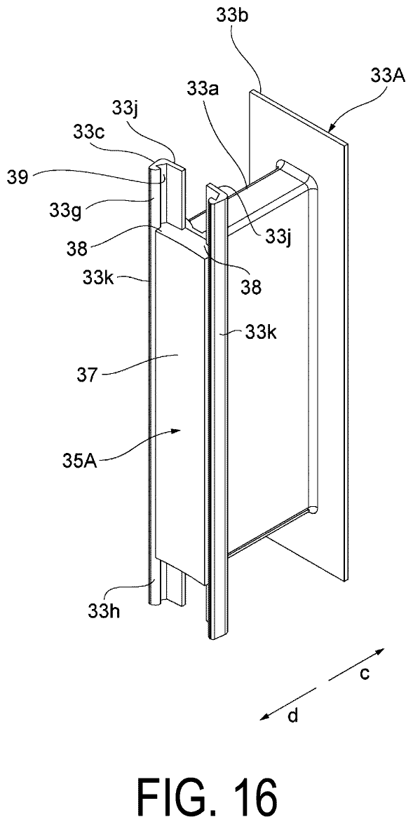

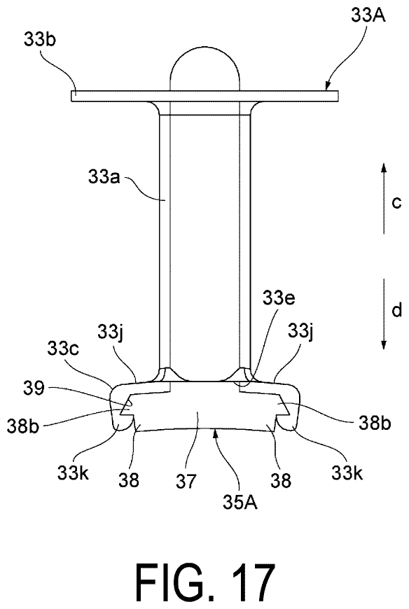

FIG. 16 is a perspective view schematically illustrating structures of the insulator 33A and the tooth 35A according to another specific example, and FIG. 17 is a plan view schematically illustrating structures of the insulator 33A and the tooth 35A according to another specific example. As illustrated in FIGS. 16 and 17, the insulator 33A includes an inner peripheral side flange 33c different from the inner peripheral side flanges of the insulators 33 of the first and second embodiments. An annular part 33a and an outer peripheral side flange 33b other than the inner peripheral side flange 33c are different in shape from the annular part and the outer peripheral side flange of the insulator 33, but have the same functions and actions as the functions and actions of the annular part and the outer peripheral side flange of the insulator 33.

Specifically, the inner peripheral side flange 33c includes a pair of peripheral walls 33j and a pair of claw parts 33k. The pair of peripheral walls 33j extends in the direction of the axial line x from an upper end part 33g to a lower end part 33h at both sides in the circumferential direction of an opening 33e of a space 33d of the annular part 33a at the inner peripheral side d. The pair of claw parts 33k extend in the radial direction from the peripheral walls 33j and then extend in directions approaching toward each other in the circumferential direction. In this way, at the upper end part 33g, the above-described recessed parts 39 are defined by the pair of peripheral walls 33j and the pair of claw parts 33k.

On the other hand, a pair of protruding parts 38 of the tooth 35A includes claw parts 38b protruding in directions away from each other in the circumferential direction. As is clear from FIG. 17, in a state of the insulator 33A being attached to the tooth 35A, the claw part 38b is locked to the claw part 33k. The claw part 38b is formed in, for example, a triangular shape in a cross-sectional view, but may have another shape as long as the locking between the claw part 38b and the claw part 33k is established.

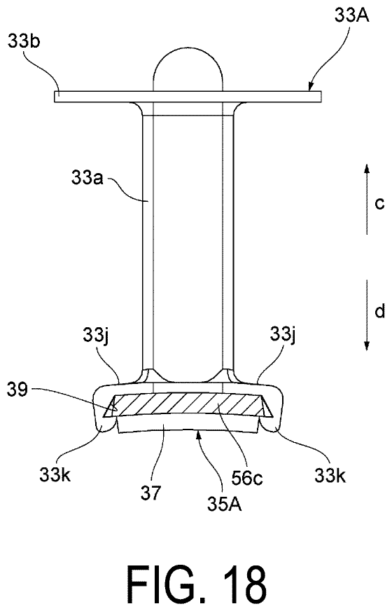

FIG. 18 is a partial cross-sectional view illustrating a state of the insulator 33A being received by the tooth 35A. As illustrated in FIG. 18, when the bus bar unit 50A is connected to the stator 30A, the connecting piece 56c of the fixing member 56 is inserted into the recessed part 39 of the insulator 33A. However, unlike the above-described connecting between the insulator 33 and the fixing member 56, the connecting piece 56c is locked to the claw part 33k to such an extent that the connecting piece 56c is held in the recessed part 39 by the pair of claw parts 33k. That is, the engaging piece 56c is not press-fitted into the recessed part 39, and the engaging piece 56c does not exert, on the claw part 33k, a stress of pushing out the recessed part 39. Thus, the bus bar unit 50A is connected to the stator 30A. Note that the connecting piece 56c may be bonded to the peripheral wall 33j and the claw part 33k with an adhesive or the like.

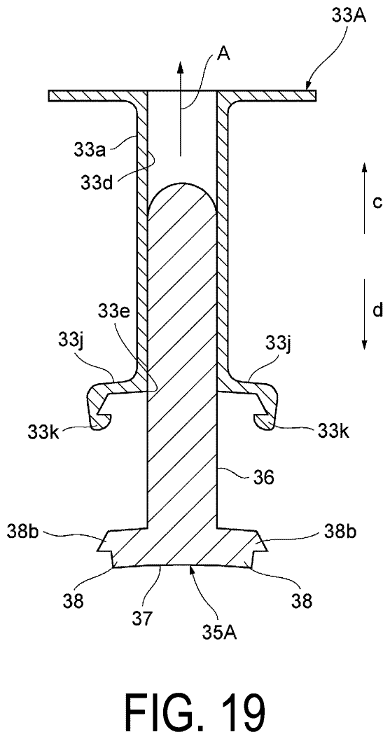

FIG. 19 is a cross-sectional view illustrating a situation of attaching the insulator 33A to the tooth 35A. At the time of attachment, the tooth 35A is inserted into the space 33d of the annular part 33a from the opening 33e of the inner peripheral side flange 33c side of the insulator 33A along an arrow A. When the tooth 35A is further inserted, the claw parts 38b of the tooth 35A elastically deforms the claw parts 33k of the insulator 33A in directions of moving the claw parts 33k and 33k away from each other in the circumferential direction. When the outer peripheral surface of the protruding part 38 of the tooth 35A comes into contact with the inner peripheral surface of the peripheral wall 33j of the outer peripheral side flange 33c of the insulator 33A, the claw part 33k returns to the original shape by an elastic restoring force. As a result, the claw part 38b is locked to the claw part 33k. Thus, the tooth 35A is connected to the insulator 33A.

In the motor 10B according to the third embodiment of the present invention as described above, the annular bus bar unit 50A including bus bars 52 is connected to the stator 30A by the connecting between the connecting piece 56c of the fixing member 56 and the recessed part 39 of the insulator 33. Vibration resistance of the bus bar unit 50A is remarkably improved. Moreover, the claw part 38b of the stator core 31 is locked to the claw part 33k of the insulator 33A. Thus, the stator core 31 and the insulator 33A are connected. As a result, vibration resistance of an assembly including the stator core 31, the coil 32, and the insulator 33A is remarkably improved.

The configurations of the motors 10, 10A, and 10B according to the first to third embodiments described above may be combined as appropriate. For example, the fixing member 56 or the insulator 33A of the motors 10A and 10B according to the second and third embodiments may be incorporated into the motor 10 according to the first embodiment. That is, in the motor 10, the bus bar unit 50 may be connected to the lid 42 with the screw 55 and may also be connected to the insulator 33 or 33A by the fixing member 56. According to such a configuration, vibration resistance of the components of the motor 10 can be further improved.

In addition, the configurations of the motors 10, 10A and 10B are not limited to the configurations of the above-described embodiments, and the present invention can be applied to any type of motor. In the above-described first to third embodiments, a brushless motor of an inner rotor type is taken as an example, but the present invention can also be applied to an outer rotor type motor. Similarly, the present invention can be applied not only to a brushless motor but also to a brush motor.

Although the present invention has been described through the above embodiments, the technical scope of the present invention is not limited to the scope described in the above embodiments. Various modifications or improvements can be made to the above embodiments, and this is obvious to a person having skill in the art. Such modified or improved form is also included in the technical scope of the present invention, and this is obvious from the description of the claims.

The above-described embodiments are intended to facilitate understanding of the present invention and are not intended to be construed as limiting. The components included in the above-described embodiments, arrangement, materials, conditions, shapes, sizes, or the like, of the components are not limited to those exemplified and may be appropriately changed. The components illustrated in the different embodiments can be replaced or combined partially to the extent not technically inconsistent.

### REFERENCE SIGNS LIST

10, 10A, 10B Motor, 11 Shaft, 12, 13 Bearing, 20 Rotor, 21 Rotor core, 22 Magnet, 30, 30A Stator, 31 Stator core, 32 Coil, 32a Lead wire, 33, 33A Insulator (insulating member), 33a Annular part, 33b Flange (outer peripheral side flange), 33c Flange (inner peripheral side flange), 33d Space, 33e Opening, 33f Fitting part, 33g Upper end part, 33h Lower end part, 33j Peripheral wall, 33k Claw part, 34 Annular part, 35, 35A Teeth, 36 Spoke, 37 Magnetic pole part, 38 Protruding part, 38a Fitted part, 38b Claw part, 39 Recessed part, 39A Peripheral wall, 39B, 39C Peripheral wall, 39D, 39E Side wall, 40 Casing, 41 Casing main body, 41a Bottom part, 41b Outer peripheral part, 42 Lid, 42a Flat plate part, 42b Opening part, 42c Opening part, 42d Through hole, 50, 50A Bus bar unit (annular member), 51 Housing, 52 Bus bar, 53 Connection terminal (internal connection terminal), 54 Connection terminal (external connection terminal), 55 Screw, 56 Fixing member, 56a Main body, 56b Leg part, 56c Piece (connecting piece), A Arrow, B Boundary line, IS Inside surface, L1 First length, L2 Second length, OS Outside surface, W Width, a Upper side, b Lower side, c Outer peripheral side, d Inner peripheral side, e Clockwise direction, f Counterclockwise direction

1. A motor comprising:
a casing;
a lid covering an opening part of the casing;
an annular member including a bus bar; and
a stator including a magnetic body and an insulating member covering the magnetic body, wherein
the annular member is connected to the lid or the insulating member, and
the magnetic body and the insulating member are connected.

2. The motor according to claim 1, wherein
the magnetic body and the insulating member are connected in a radial direction.

3. The motor according to claim 2, comprising:
a rotor, wherein
the magnetic body includes a magnetic pole part opposing the rotor,
one of an inner peripheral surface of the magnetic pole part and an outer peripheral surface of the insulating member includes a fitting part, and the other of the inner peripheral surface of the magnetic pole part and the outer peripheral surface of the insulating member includes a fitted part, and
the fitting part and the fitted part are fitted in the radial direction.

4. The motor according to claim 3, wherein
the magnetic body includes a spoke connected to the magnetic pole part,
the magnetic pole part includes two protruding parts extending from the spoke in a circumferential direction, and
the protruding part includes the fitting part or the fitted part.

5. The motor according to claim 1, comprising:
a rotor, wherein
the magnetic body includes a magnetic pole part opposing the rotor and a spoke connected to the magnetic pole part,
the magnetic pole part includes two protruding parts extending from the spoke in a circumferential direction, and
the protruding part of the magnetic body and the insulating member are fitted.

6. The motor according to claim 1, wherein
the insulating member includes a part extending toward the annular member in a rotation axis direction,
the annular member includes a part extending toward the insulating member in the rotation axis direction, and
the part of the insulating member and the part of the annular member are connected in the rotation axis direction.

7. The motor according to claim 6, wherein
the lid and the annular member are connected directly or by another member.
